(19) United States
(12) Patent Application Publication
(10) Pub. No.: US 2009/0012884 A1
(43) Pub. Date: Jan. 8, 2009

(54) METHOD AND SYSTEM FOR POPULATING TAX RETURNS USING AGGREGATED DATA

(76) Inventors: Susan A. Harman, Poway, CA (US); William Moselle, Carlsbad, CA (US); Christopher A. Schoppa, San Diego, CA (US)

Correspondence Address: PVF -- INTUIT, INC.;c/o PARK, VAUGHAN & FLEMING LLP, 2820 FIFTH STREET, DAVIS, CA, 95618-7759, US

(21) Appl. No.: 11/774,090

(22) Filed: Jul. 6, 2007

(51) Int. Cl. G06F 19/00

(52) U.S. Cl. 705/31

(57) ABSTRACT

Some embodiments of the present invention provide a system that populates a tax return using employee information obtained from a human resources system and/or employee personal profile. During operation, this system obtains employee information associated with a user from the human resources system and/or employee personal profile and then partially populates the tax return using the employee information.

### BACKGROUND

### Related Art

The present invention relates to techniques for completing tax returns. More specifically, the present invention relates to a method and apparatus for obtaining aggregated data and using the aggregated data to populate a tax return.

Every year, hundreds of millions of Americans engage in the tedious and time-consuming ritual of preparing and filing tax returns. Due to complexities in tax law, the tax preparation process is typically tedious, complicated, and costly. The tax code includes provisions which provide financial incentives designed to achieve the social, economic, and political goals of the government. In addition, the tax code may be amended to accomplish the government's goals more effectively, in response to taxpayers who manage to subvert the provisions to their advantage. As a result, repeated changes to tax law in response to taxpayers' actions may cause the tax code to become even more convoluted and difficult to understand.

Additionally, tax preparation typically involves detailed record-keeping, lengthy instructions, and/or complicated schedules, worksheets, and forms. Taxpayers often spend large amounts of time and money maintaining the information necessary to prepare and file their taxes. Consequently, taxpayers can benefit from improved understanding of tax code and associated procedures, improved record-keeping, and a more streamlined tax preparation process.

### SUMMARY

Some embodiments of the present invention provide a system that populates a tax return using employee information obtained from a human resources system and/or employee personal profile. During operation, this system obtains employee information associated with a user from the human resources system and/or employee personal profile and then partially populates the tax return using the employee information.

In some embodiments, the system also:
(1) obtains information about a life event for the user,
(2) determines a tax and/or paycheck implication of the life event,
(3) displays the tax and/or paycheck implication to the user, and
(4) allows the user to perform an action associated with the tax and/or paycheck implication.

In some embodiments, the system also obtains additional tax-related information from the user and completes the tax return using the additional tax-related information.

In some embodiments, the system also schedules a tax checkup for a predetermined time and performs the tax checkup for the user at the predetermined time.

In some embodiments, the system displays an option for populating the tax return for the user, wherein the tax return is populated based on utilizing a separate tax preparation application.

In some embodiments, the system also displays a tax and/or paycheck implication of an enrollment in a benefit to the user and allows the user to enroll in the benefit to take advantage of the tax and/or paycheck implication.

In some embodiments, the benefit is associated with at least one of an insurance plan, a retirement account, a government plan, and a flexible spending account.

In some embodiments, the system displays an option for populating the tax return to the user, wherein the tax return is populated based on a selection of the option for populating the tax return by the user.

In some embodiments, the human resources system is associated with a human resources portal or a system associated with a benefit provider.

In some embodiments, the employee information comprises at least one of: payroll data, health care data, tax withholding data, wage data, retirement account data, employee stock purchase plan data, and a personal profile of the user.

### BRIEF DESCRIPTION OF THE FIGURES

FIG. 1 shows a schematic diagram of a system for populating a tax return in accordance with an embodiment of the present invention.

FIG. 2 shows a human resources portal in accordance with an embodiment of the present invention.

FIG. 3 shows a flow chart of tax return population in accordance with an embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

Embodiments of the invention provide a method and apparatus to fill in tax returns for an employee. Specifically, embodiments of the invention provide a method and apparatus which obtains information associated with the employee from a human resources system and then populates a tax return using the obtained information. The automated population of the tax return reduces the need for an employee to maintain records of tax-related data and to manually enter data. The system can also provide a returning-user tax-preparation experience for new users of the tax preparation service and/or software. In addition, the employee information may be analyzed for tax and/or financial implications, as well as for dynamic decision support modeling regarding benefit enrollment, life events, and/or other financial decisions the employee may make.

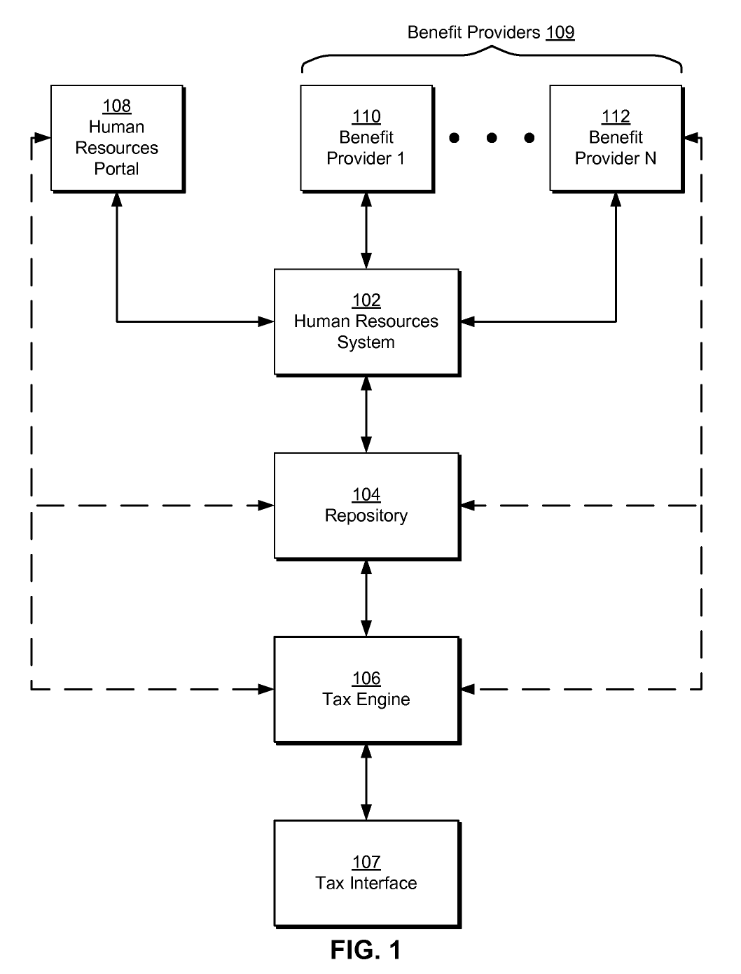

FIG. 1 shows a schematic diagram of a system for populating a tax return in accordance with an embodiment of the present invention. As shown in FIG. 1, the system includes a human resources system 102, a repository 104, a tax engine 106, and a tax interface 107. The system of FIG. 1 additionally includes a human resources portal 108 and multiple benefit providers 109. Benefit providers 109 may include and number of benefit providers, from benefit provider l 110, to benefit provider n 112, associated with human resources system 102. Each of these components is described in further detail below.

Human resources system 102 may be used by an organization (e.g., business, corporation, etc.) to manage human resources related issues for employees of the organization. Users of human resources system 102 may include an employer (e.g., manager, owner, etc.) of the organization, as well as employees of the organization. Human resources system 102 may perform functions, such as workforce planning, recruiting, induction and orientation, skills management, training and development, wage management, payroll management, employee benefits administration, and/or other human resources management related processes. Human resources system 102 may also obtain and store employee information such as employees' personal histories, employment data, skills, experiences, performance reviews, payroll records, and/or other information related to the management of employees' positions in the organization. Specifically, the employee information may include, but is not limited to, payroll data, retirement account data, health care data, tax withholding data, wage data, employee stock purchase plan (ESPP) data, and/or personal profile data. In addition, the employee information may be aggregated and/or collected from multiple sources, such as human resources portal 108 and benefit providers 109.

In one or more embodiments of the invention, human resources system 102 is implemented using a client-server architecture. More specifically, human resources system 102 may be an enterprise application running on one or more servers. In addition, human resources system 102 may be accessed from other machines using human resources portal 108. Human resources portal 108 may provide one or more interfaces (e.g., a graphical user interface) for accessing human resources system 102. For example, human resources portal 108 may be accessed by the employer and/or employees using a web browser and network connection. Alternatively, human resources portal 108 may be an application which is installed on a computing system, such as a personal computer (PC), mobile phone, personal digital assistant (PDA), and/or other digital computing device used by the employer and/or employees. Regardless of the architecture of the system, human resources portal 108 may communicate with human resources system 102 through one or more network connections and protocols. Further, the network connections and protocols may include security mechanisms, such as authentication and encryption, to protect sensitive data transferred between human resources system 102 and human resources portal 108 from unauthorized access.

In one or more embodiments of the invention, employee information is obtained and stored by human resources system 102 in repository 104. This employee information may be obtained and/or aggregated by human resources system 102 from multiple sources, including the employer, employees, and/or benefit providers 109 associated with human resources system 102. In addition, the employee information may be used to: process payroll for the employees, enroll the employee(s) with benefit provider(s) 109, manage life events of the employee(s), and/or provide other employment-related services to the employees. In one or more embodiments of the invention, repository 104 is stored in a relational database, such as a Structured Query Language (SQL) database.

As mentioned above, human resources system 102 includes functionality to enroll employees with one or more benefit providers 109. In one or more embodiments of the invention, benefit providers 109 are third-party organizations that offer employment-related services to employees. Examples of benefit providers 109 include health insurance companies, life insurance companies, dental insurance companies, retirement plans, flexible spending accounts, and bill payment services. Because benefit providers 109 are independent of human resources system 102, human resources system 102 may include an interface with each benefit provider to exchange information and associated funds so that the employees may receive benefits offered by benefit providers.

Those skilled in the art will appreciate that the employee information stored in repository 104 may be obtained at various times and/or from various sources. For example, an employer may initially enter a new employee's name and basic personal information (e.g., date of birth, address, position, salary, etc.) into human resources system 102. Once hired, the employee may fill out a personal profile using human resources portal 108. The employee may also update the personal profile as the employee experiences various life events, such as relocation, change in marital status, and/or change in dependent status. Similarly, the employer may update the employee's position, salary, performance reviews, and/or other job-related information throughout the employee's career.

Additionally, the employee may provide additional information to enroll in benefits provided by benefit providers 109 associated with human resources system 102. Human resources system 102 may obtain the additional information from the employee using human resources portal 108 and may use the additional information to enroll the employee with benefit provider(s) 109, as well as store the additional information in repository 104. Alternatively, the employee may enroll directly with benefit provider(s) 109, which may provide the enrollment-related information to human resources system 102 for record-keeping purposes. In one or more embodiments of the invention, updates to employee information received by human resources system 102 are stored in repository 104, regardless of the time of update or the source of update.

In addition, the employee information in repository 104 may be accessed by tax engine 106 to populate tax returns for the employees. In other words, employee information which is aggregated by human resources system 102 and stored in repository 104 may be obtained by tax engine 106 to perform tax preparation services. In one or more embodiments of the invention, the use of aggregated employee information in repository 104 to populate tax returns may reduce the need for manual data entry and record-keeping by the employee, thus allowing tax engine 106 to provide a returning-user experience for new users of tax engine's 106 tax preparation services.

In one or more embodiments of the invention, an option is displayed to an employee to populate a tax return using the employee information in repository 104. This option may be displayed in human resources portal 108, or may be sent to the employee in an email, text message, instant message, and/or other communications medium. Upon selection of the option, a tax return is generated and partially populated using employee information found in repository 104. The employee may then be prompted to provide additional tax-related information to tax engine 106, and tax engine 106 may complete the tax return using the additional tax-related information. On the other hand, the employee may decline the option to populate his/her tax return using information found in repository 104 and may choose to fill in the information manually. The employee may also decline to use the tax preparation service provided by tax engine 106 and may choose another tax preparation method instead.

In addition to providing tax preparation services, tax engine 106 may also analyze the employee information to determine financial and/or tax and/or paycheck implications associated with the employee information. For example, if an employee is eligible for enrollment in a benefit, tax engine 106 may place the employee's information into a model to determine the financial and/or tax and/or paycheck implications of enrolling in the benefit and any alternatives to enrolling in the benefit. Tax engine 106 may also display all options related to the benefit to the employee and may make recommendations to improve the employee's tax situation. The employee may then use human resources system 102 to make adjustments to his/her financial situation based on the recommendations.

Similarly, tax engine 106 may identify tax and/or financial implications regarding life events that are experienced and/or considered by the employee. For example, the employee may receive a pay raise, consider a purchase of a home, or plan on having a child. Tax engine 106 may fit the employee's information (e.g., income, tax filing status, etc.) into a model and determine the tax and/or paycheck implications of each potential, anticipated, or actual life event. Tax engine 106 may then present the tax and/or paycheck implications of each situation to the employee, as well as make recommendations based on the tax and/or paycheck implications. For example, tax engine 106 may suggest adjustments to the employee's tax withholding or personal budget to help the employee manage life events and finances.

In one or more embodiments of the invention, the services provided by tax engine 106 may be scheduled. For example, tax engine 106 may include functionality to perform a tax checkup at a predetermined time that may be scheduled by the employee or by tax engine 106. The tax checkup may identify potential tax and/or financial implications based on analysis of the employee information found in the repository 104. As described above, the financial and/or tax and paycheck implications may be based on analysis of the employee's life events and/or benefit enrollment decisions. In addition, tax engine 106 may provide recommendations based on the financial and/or tax implications.

Alternatively, services provided by tax engine 106 may be accessed at any time by the employee. For example, the employee may access human resources portal 104 to update his/her life events and/or enrollment in benefits. The employee may also obtain advice on the life events and/or enrollment in benefits from tax engine 106 by requesting analysis and/or recommendations from tax engine 106. On the other hand, tax engine 106 may automatically analyze the updated employee information and make recommendations if substantial financial and/or tax implications are found.

In one or more embodiments of the invention, recommendations by tax engine 106 are received by human resources system 102 and are displayed in human resources portal 104 to an employee. The employee may also make changes according to the recommendations in human resources portal 104. For example, the employee may receive a list of recommendations based on analysis of his/her information. The list of recommendations may include links to other parts of human resources portal 104 where the employee may make adjustments based on the recommendations. The employee may manually enter the adjustments into human resources portal 104, or human resources system 102 may make the adjustments on the employee's behalf if the employee accepts the recommendations.

Those skilled in the art will appreciate that human resources system 102, repository 104, and/or tax engine 106 may be components of the same system, or reside on separate systems. For example, human resources system 102 and tax engine 106 may be implemented as part of the same software system or as separate applications. Similarly, human resources system 102 and/or tax engine 106 may include repository 104 as a component, or repository 104 may be implemented independently of and/or accessed remotely by human resources system 102 and/or tax engine 106. Those skilled in the art will also appreciate that interaction between the employee and human resources system 102 and/or tax engine 106 may be facilitated through a variety of means. For example, the employee may use human resources portal 108 to access all services provided by human resources system 102 and tax engine 106, or the employee may access tax engine 106 using a separate interface (e.g., tax interface 107). The employee may also interact with human resources system 102 and/or tax engine 106 through other means, such as sending and/or receiving emails, sending and/or receiving text messages, speaking to a representative and/or automated speech recognition system, and/or using other communications media configured for interaction with human resources system 102 and/or tax engine 106.

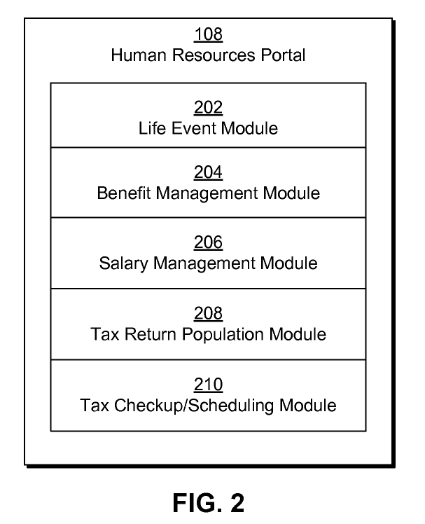

FIG. 2 shows a human resources portal in accordance with an embodiment of the present invention. As mentioned above, human resources portal 108 may provide a user interface between an employee and human resources system 102 of FIG. 1. Human resources portal 108 may be accessed using a web browser and network connection, or human resources portal 108 may be installed as an application on a computing system. Human resources portal 108 includes a life event management module 202, a benefit management module 204, a salary management module 206, a tax return population module 208, and a tax checkup/scheduling module 210.

Life event management module 202 may allow the employee to enter life event information into human resources system 102. For example, the employee may update his/her marital status, add or remove a mortgage, add or remove dependents, and/or edit other life events with financial and/or tax and paycheck implications. In addition, life event management module 202 may allow the employee to browse and/or search for financial and/or tax-related information regarding life events. Based on the life event(s) entered and/or searched or browsed for, life event management module 202 may also determine financial and/or tax implications of the life event(s) for the employee based on information stored about the employee in human resources system 102, such as annual salary, tax filing status, and/or other employee information. Life event management module 202 may also provide recommendations for optimizing the employee's financial and/or tax situation based on the life event(s), as well as direct the employee to other areas of human resources portal 108 (e.g., benefit management module 204, salary management module 206) where the employee may make changes based on the recommendations.

Benefit management module 204 may allow the employee to enroll in one or more benefits provided by human resources system 102. In one or more embodiments of the invention, the benefits are provided by outside benefit providers, such as benefit providers 109 shown in FIG. 1. Benefits available to the employee through benefit management module 204 may include healthcare plans, insurance plans, retirement accounts, healthcare spending accounts, and flexible spending accounts. The benefit management module 204 may also analyze the employee's financial and/or tax situation to determine the financial and/or tax implications of enrolling in each benefit. The benefit management module 204 may then make recommendations to the employee based on the financial and/or tax implications. For example, the employee may be hesitant to open a flexible spending account due to a potential reduction in the employee's take-home pay. Based on employee information obtained from the employee and/or human resources system, such as the employee's salary and medical expenses, benefit management module 204 may recommend a withholding amount for the flexible spending account. Benefit management module 204 may also suggest methods for increasing and/or more efficiently utilizing the employee's take-home pay, such as adjusting the employee's tax withholding or refinancing the employee's debts.

Salary management module 206 may provide salary-based information and analysis to the employee. For example, salary management module 206 may provide a breakdown of the employee's gross pay into various tax and benefit withholdings. Salary management module 206 may also provide budgeting and/or debt management recommendations to the employee. Salary management module 206 may also allow the employee to make changes to the withholdings based on recommendations by life event management module 202 and/or benefit management module 204, for example. In one or more embodiments of the invention, withholding-based recommendations by life event management module 202 and/or benefit management module 204 are received by salary management module 206. Salary management module 206 may then adjust the withholdings based on the recommendations if the recommendations are approved by the employee. Alternatively, salary management module 206 may adjust the withholdings based on preferences entered by the employee.

Tax return population module 208 may use the employee information found in human resources system 102 to populate a tax return for the employee. As described above, tax return population module 208 may seek the employee's approval for populating the tax return by presenting an option to populate the tax return to the employee. If the employee selects the option, tax return population module 208 may send the employee information to a tax engine, such as tax engine 106 of FIG. 1. The tax engine may then use the employee information to partially populate the tax return, as well as request additional tax-related information from the employee to complete the tax return. Tax return population module 208 may also serve as an interface for the tax engine, and the employee may use tax return population module 208 to both select the option for populating the tax return and complete the tax return using the additional tax-related information provided by the employee.

Tax checkup/scheduling module 210 may allow the employee to schedule services provided by other modules (e.g., life event management module 202, a benefit management module 204, a salary management module 206, a tax return population module 208) in human resources portal 108. As mentioned above, the employee may receive a tax checkup at a predetermined time. The time may be scheduled by the employee, or by an automated system associated with human resources portal 108. The tax checkup may be scheduled for a one-time occurrence, or on a regular basis (e.g., weekly, monthly, quarterly, annually, etc.). Further, the tax checkup may include services provided by some or all of the other modules (e.g., life event management module 202, a benefit management module 204, a salary management module 206, a tax return population module 208) in human resources portal 108.

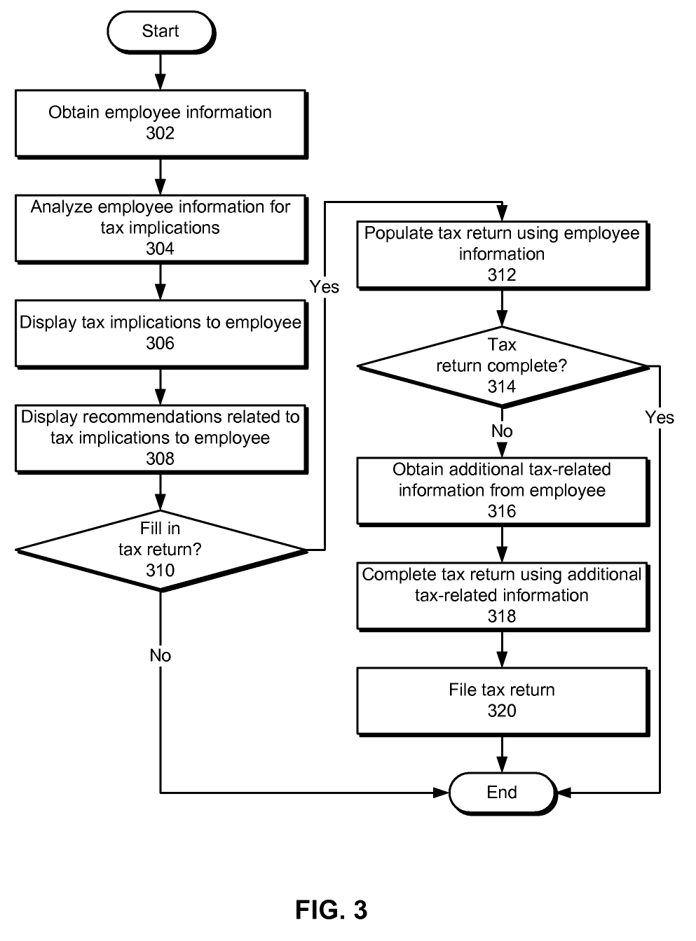

FIG. 3 shows a flow chart of the tax return population process in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

Initially, employee information associated with an employee is obtained (operation 302). As described above, the employee information may be obtained at various times and/or from various sources. For example, an employer may provide the employee's job title, salary, and responsibilities upon hire, the employee may provide and update his/her personal information throughout his/her employment, and one or more benefit providers may provide enrollment-related information upon the employee's enrollment with benefit provider(s). This employee information may include, but is not limited to, payroll data, retirement account data, health care data, tax withholding data, wage data, employee stock purchase plan (ESPP) data, and/or personal profile data. The employee information may also be stored in a repository, such as repository 104 of FIG. 1.

The employee information is analyzed for tax and/or paycheck implications (operation 304). For example, various life events and/or benefits pertinent to the employee may be entered into a model to determine the financial and/or tax and paycheck implications of the life events and/or benefits. The financial and/or tax implications are displayed to the employee (operation 306). In addition, one or more recommendations related to the financial and/or tax implications are displayed to the employee (operation 308). The recommendations may include adjustments to the employee's tax and/or benefits withholdings, adjustments to the employee's enrollment in benefits, creation of and/or changes to the employee's budget, and/or other financial and/or tax-based recommendations. These recommendations may also help the employee choose between benefits such as health care plans and/or make decisions regarding certain life events, such as owning a home. The employee may select one or more of the recommendations, or the employee may decline to make any changes based on the recommendations.

A determination is made regarding the population of a tax return with the employee information (operation 310). As mentioned above, the determination may be made by presenting an option to populate the tax return to the employee. If the employee selects the option, the tax return is populated (operation 312) using the employee information.

Based on the completeness of the tax return (operation 314), additional information may be requested from the employee. For example, information about the employee's deductions may be missing from the tax return. If the tax return is only partially populated using the employee information, additional tax-related information is obtained from the employee (operation 316). The tax-related information may be obtained in various ways, including by requesting documents from the employee and/or asking the employee a series of questions. The tax return is then completed using the additional tax-related information (operation 318), and the tax return is filed (operation 320).

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for filling in a tax return, comprising:
obtaining employee information associated with a user from a human resources system; and
using the employee information to partially populate the tax return for the user.

2. The method of claim 1, further comprising:
obtaining information about a life event for the user;
determining a tax and/or paycheck implication of the life event;
displaying the tax and/or paycheck implication to the user; and
allowing the user to perform an action associated with the tax and/or paycheck implication.

3. The method of claim 1, further comprising:
obtaining additional tax-related information from the user; and
completing the tax return using the additional tax-related information.

4. The method of claim 1, further comprising:
displaying an option for populating the tax return for the user,
wherein the tax return is populated based on a selection of the option for populating the tax return by the user.

5. The method of claim 1, further comprising displaying an option for populating the tax return for the user, wherein the tax return is populated based on utilizing a separate tax preparation application.

6. The method of claim 1, further comprising:
scheduling a tax checkup for a predetermined time; and
performing the tax checkup for the user at the predetermined time.

7. The method of claim 1, further comprising:
displaying a tax and/or paycheck implication of an enrollment in a benefit to the user; and
allowing the user to enroll in the benefit to take advantage of the tax and/or paycheck implication.

8. The method of claim 7, wherein the benefit is associated with at least one of:
a healthcare plan
an insurance plan;
a retirement account;
a government plan;
a healthcare spending account; and
a flexible spending account.

9. The method of claim 1, wherein the human resources system is associated with at least one of:
a human resources portal; and
a system associated with a benefit provider.

10. The method of claim 1, wherein the employee information comprises at least one of:
payroll data;
health care data;
tax withholding data;
wage data;
retirement account data;
employee stock purchase plan data; and
a personal profile of the user.

11. A system for filling in a tax return, comprising:
a human resources system configured to obtain employee information associated with a user;
a repository configured to store the employee information; and
a tax engine configured to partially populate the tax return using the employee information.

12. The system of claim 11, wherein the tax engine is further configured to:
obtain information about a life event for the user;
determine a tax and/or paycheck implication of the life event;
display the tax and/or paycheck implication to the user; and
allow the user to perform an action associated with the tax and/or paycheck implication.

13. The system of claim 11, wherein the tax engine is further configured to:
obtain additional tax-related information from the user; and
complete the tax return using the additional tax-related information.

14. The system of claim 11, wherein the tax engine is further configured to:
display an option for populating the tax return to the user; and
wherein the tax return is populated based on a selection of the option for populating the tax return by the user.

15. The system of claim 11, wherein the tax engine is further configured to display an option for populating the tax return for the user, wherein the tax return is populated based on utilizing a separate tax preparation application.

16. The system of claim 11, wherein the tax engine is further configured to:
schedule a tax checkup for a predetermined time; and
perform the tax checkup for the user at the predetermined time.

17. The system of claim 11, wherein the tax engine is further configured to:
display a tax and/or paycheck implication of an enrollment in a benefit to the user; and
allow the user to enroll in the benefit to take advantage of the tax and/or paycheck implication.

18. The system of claim 17, wherein the benefit is associated with at least one of:
a healthcare plan;
an insurance plan;
a retirement account;
a government plan;
a healthcare spending account; and
a flexible spending account.

19. The system of claim 11, wherein the human resources system is associated with at least one of:
a human resources portal; and
a system associated with a benefit provider.

20. The system of claim 11, wherein the employee information comprises at least one of:
payroll data;
health care data;
tax withholding data;
wage data;
retirement account data;
employee stock purchase plan data; and
a personal profile of the user.

21. A computer-readable storage medium storing instructions that when executed by a computer cause the computer to perform a method for filling in a tax return, the method comprising:
obtaining employee information associated with a user from a human resources system; and
using the employee information to partially populate the tax return for the user.

22. The computer-readable storage medium of claim 21, the method further comprising:
obtaining information about a life event for the user;
determining a tax and/or paycheck implication of the life event;
displaying the tax and/or paycheck implication to the user; and
allowing the user to perform an action associated with the tax and/or paycheck implication.

23. The computer-readable storage medium of claim 21, the method further comprising:
obtaining additional tax-related information from the user; and
completing the tax return using the additional tax-related information.

24. The computer-readable storage medium of claim 21, the method further comprising:
displaying an option for populating the tax return to the user,
wherein the tax return is populated based on a selection of the option for populating the tax return by the user.

25. The computer-readable storage medium of claim 21, the method further comprising displaying an option for populating the tax return for the user, wherein the tax return is populated based on utilizing a separate tax preparation application.

26. The computer-readable storage medium of claim 21, the method further comprising:
scheduling a tax checkup for a predetermined time; and
performing the tax checkup for the user at the predetermined time.

27. The computer-readable storage medium of claim 21, the method further comprising:
displaying a tax and/or paycheck implication of an enrollment in a benefit to the user; and
allowing the user to enroll in the benefit to take advantage of the tax and/or paycheck implication.

28. The computer-readable storage medium of claim 27, wherein the benefit is associated with at least one of:
a healthcare plan;
an insurance plan;
a retirement account;
a government plan;
a healthcare spending account; and
a flexible spending account.

29. The computer-readable storage medium of claim 21, wherein the human resources system is associated with at least one of:
a human resources portal; and
a system associated with a benefit provider.

30. The computer-readable storage medium of claim 21, wherein the employee information comprises at least one of:
payroll data;
health care data;
tax withholding data;
wage data;
retirement account data;
employee stock purchase plan data, and
a personal profile of the user.

31. A computer system that fills in tax returns, comprising:
a processor;
a memory; and
code which can be stored in the memory and is configured to:
obtain employee information associated with a user from a human resources system; and
use the employee information to partially populate the tax return for the user.
